(19) United States
(12) Patent Application Publication
(10) Pub. No.: US 2023/0033411 A1
(43) Pub. Date: Feb. 2, 2023

(54) IMPROVED ACOUSTIC FOAM PROFILE FOR PNEUMATIC TIRES

(71) Applicant: Compagnie Generale des Etablissements Michelin, Cermont-Ferrand (FR)

(72) Inventors: Ryan Michael GAYLO, Greenville, SC (US); Frederic SARAZIN, Le Crest (FR); Neal LEIFHEIT, Greenville, SC (US)

(21) Appl. No.: 17/789,211

(22) PCT Filed: Dec. 26, 2019
(86) PCT No.: PCT/US2019/068537

§ 371 Date: Jun. 26, 2022

(51) Int. Cl. B60C 19/00

(52) U.S. Cl. CPC B60C 19/002

(57) ABSTRACT

A tire having an adhesive sealant applied to the radial interior of the tire in the region of the belt reinforcements of the crown with a noise-dampening foam ring having circumferential grooves in the radial outside surface of the foam is applied to the adhesive sealant. The grooves of the foam are laterally aligned with the circumferential grooves of the tire such that the foam touches the sealant on areas that are not laterally aligned with the longitudinal grooves of the tire.

### FIELD OF THE INVENTION

The subject matter of the present invention relates to tires, and more specifically to tires having on their radially inner surface a layer of a sealant intended to seal a puncture in the crown of the tire and a strip of foam intended to damp the cavity noise.

### BACKGROUND OF THE INVENTION

The development of motor vehicle technology has lead to a demand for the reduction of noise perceived by the occupants of the vehicle. In particular, electrical propulsion has reduced compartment noise levels such that the noise of the tires, and in particular the noise associated with the internal cavity of the tire while rolling, has become noticeable. Attaching foam strips to the internal surface of the pneumatic tire have proved to be a successful method to dampen the audible tire cavity, for example, U.S. Pat. No. 7,975,740.

The pneumatic tire still is subject to punctures and air loss as a result of those punctures. To mitigate or eliminate the air loss due to puncture, tire manufactures may apply a self-sealing product upon the radially inner surface of the inner-liner of the tire. When a nail, or other object, penetrates the tire crown, the sealant, because of the product's softness and ability to creep readily, penetrates the puncture and prevents the pneumatic tire from losing air. Such a tire with a layer able to creep and seal the puncture is said to be a “self-sealing tire.” The grooves of the tire being the thinnest portion of the tire's tread are particularly susceptible to penetration damage.

With the advent of electric vehicles, it has become desirous to combine these technologies, such as shown in U.S. Pat. App. Pub. No. US 2016/0347127. Combining the technologies, however, have been met with certain difficulties. In particular, the acoustic foam 100, when applied on the self-sealing layer 50, such as the cross section of the tire 10 shown in FIG. 1, reduces the effectiveness of the self-sealing abilities of the tire 10, resulting in a need for additional self-sealing product and/or acceptance of a reduction of the self-sealing performance. The additional self-sealing product needed for improved effectiveness is both expensive and adds unnecessary additional weight to the tire.

Attempts to increase the effectiveness of the self-sealing layer have been made. One such attempt, as shown in FIG. 2, is where the radially outer surface of acoustic foam 100 is cut to form a U-shape profile. When installed, the acoustic foam 100 touches and secures itself to the self-sealing layer 50 at the lateral ends 102, 104 of the acoustic foam 100, leaving the middle portion radially inward from the self-sealing layer. In practice, however, it is difficult to achieve such careful positioning, and even when achieved, inadvertent compression of the acoustic foam 100 results, as shown in FIG. 3, in the middle portion adhering to the self-sealing layer, resulting in decreased self-sealing performance and tire imbalance.

An acoustic foam profile which does not appreciably interfere with the effectiveness of the self-sealing layer is desirous. In particular a foam profile which does not interfere with the effectiveness of the self-sealing layer and prevents the acoustic foam structure from collapsing into the self-sealing layer would be particularly advantageous.

### SUMMARY OF THE INVENTION

Aspects and advantages of the invention will be set forth in part in the following description, or may be obvious from the description, or may be learned through practice of the invention.

In one embodiment, a polyalphaolefin adhesive sealant is applied to the radial interior of the tire in the region of the belt reinforcements of the crown. A noise-dampening foam ring having circumferential grooves in the radial outside surface of the foam is applied to the adhesive sealant. The grooves of the foam are laterally aligned with the circumferential grooves of the tire such that the foam touches the sealant on areas that are not laterally aligned with the longitudinal grooves of the tire. This prevents the foam from hindering the flow of sealant in the area immediately below the tread grooves improving the self-sealing performance of the tire.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a cross-section view of a prior art tire having acoustic foam and a self-sealing product layer applied to the interior taken through the axis of rotation of the tire.

FIG. 2 provides a cross-section view of a prior art tire having U-shaped acoustic foam and a sealant layer applied to the interior.

FIG. 3 provides a cross-section view of a prior art tire having U-shaped acoustic foam and a sealant layer applied to the interior with the U-shaped acoustic foam collapsed into the sealant layer.

FIG. 4 provides a cross-section view of an embodiment of the invention, having acoustic foam and a sealant layer applied to the interior of a pneumatic tire.

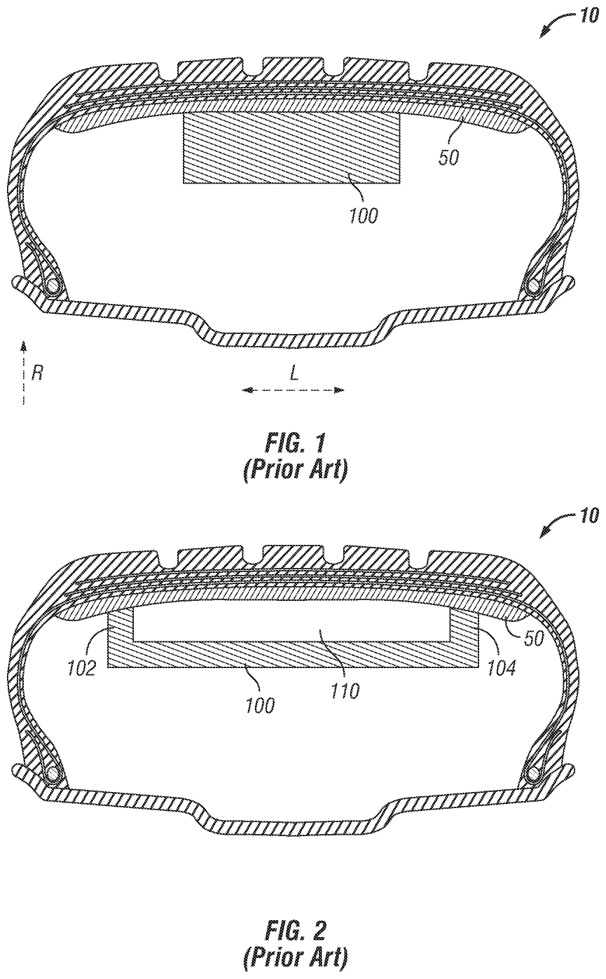

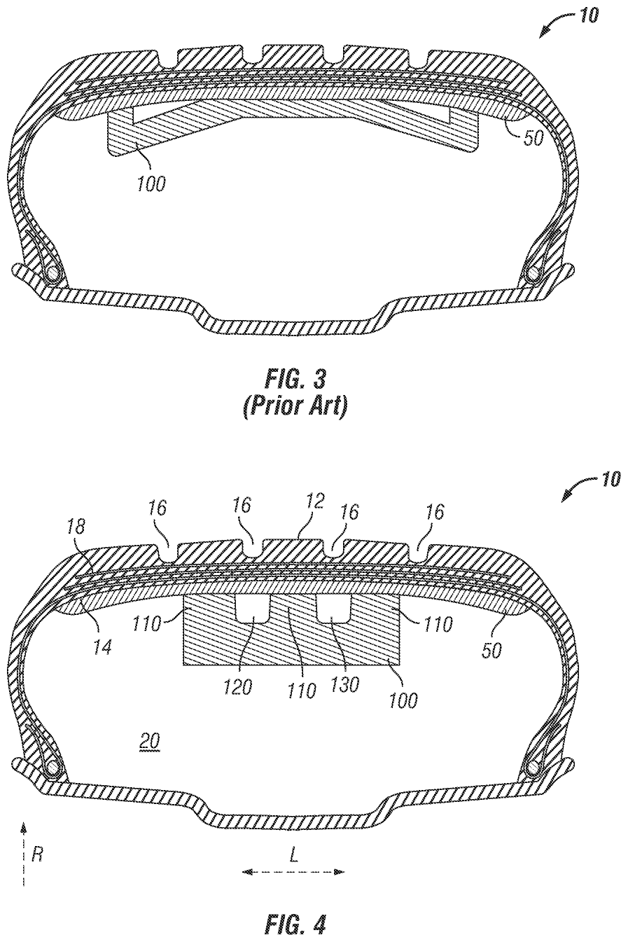

The use of identical or similar reference numerals in different figures denotes identical or similar features.

### DETAILED DESCRIPTION OF THE INVENTION

The present invention provides a pneumatic tire having a layer of self-sealing product applied to the interior of the pneumatic tire in the crown region with a layer of acoustic foam applied to the surface of the self-sealing product. For purposes of describing the invention, reference now will be made in detail to embodiments and/or methods of the invention, one or more examples of which are illustrated in or with the drawings. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

The following terms are defined as follows for this disclosure:

“Axial direction” or the letter “A” in the figures refers to a direction parallel to the axis of rotation of for example, the tire, and/or wheel as it travels along a road surface.

“Radial direction” or the letter “R” in the figures refers to a direction that is orthogonal to the axial direction and extends in the same direction as any radius that extends orthogonally from the axial direction.

“Equatorial plane” means a plane that passes perpendicular to the axis of rotation and bisects the outer tread band and/or wheel structure.

“Circumferential direction” or the letter “C” in the figures refers to a direction is orthogonal to the axial direction and orthogonal to a radial direction.

“Radial plane” means a plane that passes perpendicular to the equatorial plane and through the axis of rotation of the wheel.

“Lateral direction” or the letter “L” means a direction that is orthogonal to an equatorial plane.

FIG. 4 provides an exemplary embodiment of a tire 10 having a tread surface 12 having a plurality of circumferential tread grooves 16 on the tread surface 12. The inner surface 14 of the tire 10 faces an internal cavity 20 which is made when the tire is mounted upon a rim 40. A self-sealing adhesive layer 50 is positioned on the inner surface 14 of the tire. The adhesive layer 50 is positioned circumferentially around the interior surface 14 of the tire 10 and is laterally aligned with the belt reinforcement layers 18 of the tire. The self-sealing adhesive layer 50 in this embodiment is a gel comprised of polyurethane. Other materials may be used, including a sealant comprised of polyalphaolefin.

A strip of noise dampening foam 100 is attached on the radially inner surface of the self-sealing adhesive layer 50. The noise dampening foam 100 has a plurality of circumferential grooves 120, 130. Each of the circumferential grooves 120, 130 face the interior surface 14 of the tire 10. In this embodiment, support walls 110 forming the lateral sides of the circumferential grooves 120, 130 of the noise dampening foam 100 contact the self-sealing adhesive layer 50 securing the noise dampening foam 100 to the interior of the tire 10. The support walls 110 help keep the bottom surfaces of the circumferential grooves 120, 130 from making contact with the adhesive layer during installation and during the tire's operation. The support walls 110 make contact with the self-sealing adhesive 50 in the region laterally between the circumferential tread grooves 16 of the tire 10.

Each of the circumferential grooves 120, 130 of the noise dampening foam are positioned in lateral alignment with one of the plurality of circumferential tread grooves 16. In other words, in the present embodiments, each circumferential tread groove 16 does not have foam contacting the self-sealing adhesive layer that lies below it. If the tire is pierced by a foreign object within the tread groove 16, the self-sealing adhesive material 50 is able to flow unrestricted by the foam 100 to fill the puncture caused by the foreign object.

In this embodiment, only two circumferential grooves 120, 130 in the foam are shown. Other embodiments may have three grooves, four grooves, five grooves or more depending upon how many longitudinal tread grooves 16 that the noise dampening foam 100 laterally spans. In this embodiment, the noise dampening foam laterally spans only two grooves 16 thus it only contains two grooves 120, 130 in the foam 100.

The noise dampening foam may be in the form of a strip having two ends. The two ends may be bonded together. The two ends of the noise dampening foam may be butted against one another or alternatively may be separated by a gap. The noise dampening foam strip may be in the form of a continuous ring.

The lateral width of each of the grooves 120, 130 of the noise dampening foam 100 are wider than the width of the tire tread groove 16 of which it is laterally aligned with. In the embodiment shown, the grooves of the noise dampening ring are 15.5 mm wide in the lateral direction and 10 mm deep in the radial direction while the tread grooves are 5 mm wide as measured at the bottom of the tread groove 16 and approximately 10 mm wide at the radial outer surface of the tread 12.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm” Also, the dimensions and values disclosed herein are not limited to a specified unit of measurement. For example, dimensions expressed in English units are understood to include equivalent dimensions in metric and other units (e.g., a dimension disclosed as “1 inch” is intended to mean an equivalent dimension of “2.5 cm”). When the term “approximately” is used, it should be understood to include dimensions that are 25% larger or 25% smaller than the value stated.

As used herein, the term “method” or “process” refers to one or more steps that may be performed in other ordering than shown without departing from the scope of the presently disclosed invention. As used herein, the term “method” or “process” may include one or more steps performed at least by one electronic or computer-based apparatus. Any sequence of steps is exemplary and is not intended to limit methods described herein to any particular sequence, nor is it intended to preclude adding steps, omitting steps, repeating steps, or performing steps simultaneously. As used herein, the term “method” or “process” may include one or more steps performed at least by one electronic or computer-based apparatus having a processor for executing instructions that carry out the steps.

The terms “a,” “an,” and the singular forms of words shall be taken to include the plural form of the same words, such that the terms mean that one or more of something is provided. The terms “at least one” and “one or more” are used interchangeably. Ranges that are described as being “between a and b” are inclusive of the values for “a” and “b.”

Every document cited herein, including any cross-referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

1. A spoke for a non-pneumatic tire, the spoke connecting a radially inner surface of a radially outer compliant band to a radially outer surface of a hub, the tire defining an axis of rotation about its center and a medial plane tangent to the axis of rotation, the spoke comprising:
a radially outer support element having a radially inner end, a radially outer end, a first side and a second side;
a radially outer elastomeric joint body connecting the radially outer end of the radially outer support element to the radially outer compliant band, the radially outer elastomeric joint body positioned on said second side of said radially outer support element, the radially outer elastomeric joint body having a first surface on the same side of the radially outer elastomeric joint body as the first side of said radially outer support element and a second surface on the same side of the radially outer elastomeric joint body as the second side of said radially outer support element, the elastomeric radially outer joint body having a thickness measured in the circumferential direction at a particular radial distance from a radial outer surface of the radially outer elastomeric joint body, the thickness measured as the circumferential distance between the first surface and the second surface of the radially outer elastomeric joint body at a particular radial distance from a radial outer surface of the radially outer elastomeric joint body;
the radially outer support element further comprising one or more elongated reinforcements having a flexural rigidity greater than the elastomer comprising the radially outer joint body, the reinforcement having a length and a thickness measured perpendicular to the length;
the radially outer elastomeric joint body further comprising an aperture positioned a distance no greater than two thirds of the minimum thickness of the radially outer elastomeric joint body from the first surface of the radially outer elastomeric joint body.

2. The spoke of claim 1 further comprising:
a radially inner support element having a radially inner end, a radially outer end, a first side and a second side, said radially outer support element forming an interior angle with said radially inner support element, said interior angle positioned on a first side of the radially inner support element and the first side of the radially inner support element,
a middle elastomeric joint body connecting said radially inner support element radially outer end and said radially outer support element radially inner end, said middle elastomeric joint body positioned on the first side said first support element and the first side of said radially inner support element, the middle elastomeric joint body having a first surface on the first side of the first support element and the second support element and a second surface on the second side of the first support element and the second support element, the middle elastomeric joint body having a thickness measured as the circumferential distance between the first surface of the middle elastomeric joining body and the second surface of the middle elastomeric joint body measured at a particular radial distance from a radial outer surface of the radially outer elastomeric joint body.

3. The spoke of claim 2 further comprising:
a radially inner elastomeric joint body connecting said radially inner support element radially inner end to said radially hub and positioned on said second side of said radially inner support element, the radially inner elastomeric joint body having a first surface on the same side of the radially inner elastomeric joint body as the first side of the radially inner support element and a second surface on the same side of the radially inner elastomeric joint body as the second side of the radially inner support element, the radially inner elastomeric joint body having a thickness measured in the circumferential direction measured at a particular radial distance from a radial inner surface of the radially inner elastomeric joint body, the thickness measured as the circumferential distance between the first surface and the second surface of the radially inner elastomeric joint body measured at a particular radial distance from a radial inner surface of the radially inner elastomeric joint body;
the radially inner elastomeric joint body further comprising an aperture positioned a distance no greater than two thirds of the minimum thickness of the radially inner elastomeric joint body from the first surface of the radially inner elastomeric joint body.

4. The spoke of claim 2 wherein the middle elastomeric joint body further comprises a second aperture positioned a distance no greater than one half of the minimum thickness of the middle elastomeric joint body from the first surface of the middle elastomeric joint body.

5. The spoke of claim 1 wherein the aperture of the radially outer elastomeric joint body passes laterally through the elastomeric joint body.

6. The spoke of claim 1 wherein the aperture of the radially outer elastomeric joint body is a closed curve with a convex interior.

7. The spoke of claim 6 wherein the aperture of the radially outer elastomeric joint body is oval.

8. The spoke of claim 6 wherein the aperture of the radially outer elastomeric joint body is circular.

9. The spoke of claim 7 wherein the aperture of the radially outer elastomeric joint body has a minor diameter of approximately five times the thickness of the elongated reinforcement and a major diameter of approximately seven times the thickness of the elongated reinforcement.

10. The spoke of claim 7 wherein the aperture of the radially outer elastomeric joint body has a minor diameter of approximately 5 mm and a major diameter of approximately 7 mm.

11. The spoke of claim 1 wherein the radially inner support element is comprised of one or more elongated reinforcements having a flexural rigidity greater than the elastomer comprising the radially outer joint body.

12. The spoke of claim 1 wherein said radially outer support element radially outer end is a free end.

13. The spoke of claim 1 wherein the thickness of the reinforcement is 1 mm.

14. The spoke of claim 3 wherein the aperture of the radially inner elastomeric joint body is an oval having a major diameter of seven times the thickness of the elongated reinforcement of the radially inner support element and a minor diameter of five times the thickness of the elongated reinforcement of the radially inner support element, the aperture of the radially outer elastomeric joint body is an oval having a major diameter of seven times the thickness of the elongated reinforcement of the radially outer support element and a minor diameter of five times the thickness of the elongated reinforcement of the radially outer support element, and the aperture of the middle elastomeric joint body is an circle having a diameter of five times the thickness of the elongated reinforcement of the radially inner support element

15. The spoke of claim 13 wherein the aperture of the radially inner elastomeric joint body has the major diameter positioned in the circumferential direction and the aperture of the radially outer elastomeric joint body has the major diameter positioned in the circumferential direction.

16. The spoke of claim 14 wherein the aperture of the radially outer elastomeric joint body passes laterally through the radially outer elastomeric joint body, the aperture of the middle elastomeric joint body passes laterally through the middle elastomeric joint body, wherein the aperture of the radially outer elastomeric joint body passes laterally through the elastomeric joint body, and wherein the aperture of the radially inner elastomeric joint body passes laterally through the radially inner elastomeric joint body.

17. The spoke of claim 1 wherein the aperture of the radially outer elastomeric joint body is a semicircle with a portion of the aperture wall comprised of a portion of the radially outer compliant band.

18. The spoke of claim 1 wherein the aperture of the radially outer elastomeric joint body is filled with a material having a lower density than the radially outer elastomeric joint body.

19. A spoke for a non-pneumatic tire, the spoke connecting a radially inner surface of a radially outer compliant band to a radially outer surface of a hub, the tire defining an axis of rotation about its center and a medial plane tangent to the axis of rotation, the spoke comprising:
a radially outer support element having a radially inner end, a radially outer end, a first side and a second side;
a radially inner support element having a radially inner end, a radially outer end, a first side and a second side, said radially outer support element forming an interior angle with said radially inner support element, said interior angle positioned on a first side of the radially inner support element and the first side of the radially inner support element;
a middle elastomeric joint body connecting said radially inner support element radially outer end and said radially outer support element radially inner end, said middle elastomeric joint body positioned on the first side said first support element and the first side of said radially inner support element, the middle elastomeric joint body having a first surface on the first side of the first support element and the second support element and a second surface on the second side of the first support element and the second support element, the middle elastomeric joint body having a thickness measured as the circumferential distance between the first surface of the middle elastomeric joining body and the second surface of the middle elastomeric joint body measured at a particular radial distance from a radial outer surface of the radially outer elastomeric joint body;
a radially outer elastomeric joint body connecting the radially outer end of the radially outer support element to the radially outer compliant band, the radially outer elastomeric joint body positioned on said second side of said radially outer support element, the radially outer elastomeric joint body having a first surface on the same side of the radially outer elastomeric joint body as the first side of said radially outer support element and a second surface on the same side of the radially outer elastomeric joint body as the second side of said radially outer support element, the elastomeric radially outer joint body having a thickness measured in the circumferential direction at a particular radial distance from a radial outer surface of the radially outer elastomeric joint body, the thickness measured as the circumferential distance between the first surface and the second surface of the radially outer elastomeric joint body at a particular radial distance from a radial outer surface of the radially outer elastomeric joint body;
a radially inner elastomeric joint body connecting said radially inner support element radially inner end to said radially hub and positioned on said second side of said radially inner support element, the radially inner elastomeric joint body having a first surface on the same side of the radially inner elastomeric joint body as the first side of the radially inner support element and a second surface on the same side of the radially inner elastomeric joint body as the second side of the radially inner support element, the radially inner elastomeric joint body having a thickness measured in the circumferential direction measured at a particular radial distance from a radial inner surface of the radially inner elastomeric joint body, the thickness measured as the circumferential distance between the first surface and the second surface of the radially inner elastomeric joint body measured at a particular radial distance from a radial inner surface of the radially inner elastomeric joint body;
the radially inner elastomeric joint body further comprising an aperture positioned a distance no greater than two thirds of the minimum thickness of the radially inner elastomeric joint body from the first surface of the radially inner elastomeric joint body;
the radially outer support element further comprising one or more elongated reinforcements having a flexural rigidity greater than the elastomer comprising the radially outer joint body, the reinforcement having a length and a thickness measured perpendicular to the length;
the radially outer elastomeric joint body further comprising an aperture positioned a distance no greater than two thirds of the minimum thickness of the radially outer elastomeric joint body from the first surface of the radially outer elastomeric joint body.

20. The spoke of claim 19 wherein the aperture of the radially outer elastomeric joint body passes laterally through the elastomeric joint body.
